(19) United States
(12) Patent Application Publication
(10) Pub. No.: US 2025/0376195 A1
(43) Pub. Date: Dec. 11, 2025

(54) VEHICLE CONTROL APPARATUS

(71) Applicant: Honda Motor Co., Ltd., Tokyo (JP)

(72) Inventors: Tokitomo Ariyoshi, Wako-shi, Saitama (JP); Yuki Kizumi, Wako-shi, Saitama (JP); Tadahiko Kanoh, Wako-shi, Saitama (JP); Shingo Ito, Wako-shi, Saitama (JP)

(21) Appl. No.: 18/833,890

(22) PCT Filed: Jan. 31, 2022
(86) PCT No.: PCT/JP2022/003621

§ 371 Date: Feb. 13, 2025

(51) Int. Cl. B60W 60/00; G06V 20/56

(52) U.S. Cl. CPC B60W 60/0059; G06V 20/588; B60W 2420/403; B60W 2552/53

(57) ABSTRACT

A vehicle control apparatus (100) includes: an imaging unit (1) and an imaging unit (2) configured to detect an external situation in a predetermined region in a surrounding of the subject vehicle, respectively; recognition units (1a, 2a) configured to recognize the external situation in the surroundings of the subject vehicle based on a detection value by the imaging unit 1, and recognize the external situation in the surroundings of the subject vehicle based on a detection value by the imaging unit 2; and a determination unit (111) configured to determine either the self-driving capability or the driving support capability to be applied to the subject vehicle, based on a difference between a recognition result based on the detection value by the imaging unit (1) and a recognition result based on the detection value of the by the imaging unit (2), recognized by the recognition units (1a, 2a).

### TECHNICAL FIELD

This invention relates to a vehicle control apparatus that controls traveling operation of a vehicle.

### BACKGROUND ART

As a device of this type, there has been conventionally known a device that determines a possibility that a subject vehicle departs from a lane, based on an image obtained by imaging the surroundings of the subject vehicle, and switches a traveling support capability in accordance with its determination result (see, for example, Patent Literature 1). The device described in Patent Literature 1 recognizes a division line that defines a traveling lane of the subject vehicle, based on a captured image obtained by an imaging unit that images a forward side of the subject vehicle and an imaging unit that images a rearward side of the subject vehicle.

### CITATION LIST

### Patent Literature

Patent Literature 1: Japanese Patent No. 4654208

### DISCLOSURE OF INVENTION

### Problems to be Solved by the Invention

As the device described in Patent Literature 1, however, in a case where the division line is recognized, based on the captured images that have been obtained by a plurality of cameras respectively having different imaging ranges, it is necessary to align coordinate systems of the plurality of captured images, and an error is likely to occur when the division line is recognized.

### Means for Solving Problem

An aspect of the present invention is a vehicle control apparatus configured to controlling a subject vehicle having either a self-driving capability or a driving support capability, the vehicle control apparatus including: a first environment detection unit and a second external environment detection unit configured to detect an external situation in a predetermined region in a surrounding of the subject vehicle, respectively; a recognition unit configured to recognize the external situation in the surroundings of the subject vehicle based on a detection value by the first external environment detection unit, and recognize the external situation in the surroundings of the subject vehicle based on a detection value by the second external environment detection unit; and a determination unit configured to determine either the self-driving capability or the driving support capability to be applied to the subject vehicle, based on a difference between a recognition result based on the detection value by the first external environment detection unit and a recognition result based on the detection value of the by the second external environment detection unit.

### Effect of the Invention

According to the present invention, an external situation in the surroundings of the subject vehicle can be accurately recognized, and the self-driving capability or the driving support capability corresponding to the external situation can be appropriately determined.

### BRIEF DESCRIPTION OF THE DRAWINGS

FIG. 1 is a block diagram schematically illustrating a substantial configuration of a vehicle control apparatus according to an embodiment of the present invention,

FIG. 2 is a diagram illustrating an example of a vehicle to which the vehicle control apparatus is applied,

FIG. 3 is diagram illustrating an example of a table for determining a self-driving level,

FIG. 4A is diagrams for describing an example of an operation of the vehicle control apparatus,

FIG. 4B is diagrams for describing another example of the operation of the vehicle control apparatus,

FIG. 4C is diagrams for describing another example of the operation of the vehicle control apparatus,

FIG. 4D is diagrams for describing another example of the operation of the vehicle control apparatus, and

FIG. 5 is a block diagram schematically illustrating a substantial configuration of a vehicle control apparatus according to a modification of an embodiment of the present invention.

### DESCRIPTION OF EMBODIMENT

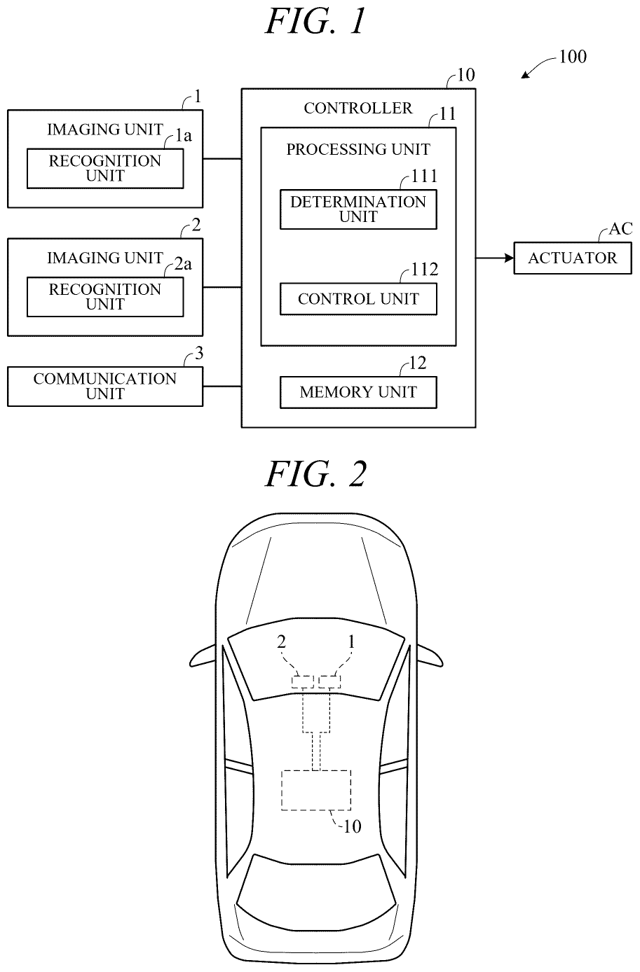

Hereinafter, embodiments of the present invention will be described with reference to FIGS. 1 to 5. A vehicle control apparatus according to an embodiment of the present invention is applicable to a vehicle having the self-driving capability, that is, a self-driving vehicle. Note that a vehicle to which the vehicle control apparatus according to the present embodiment is applied will be referred to as a subject vehicle to be distinguished from other vehicles, in some cases. The subject vehicle may be any of an engine vehicle having an internal combustion (engine) as a traveling drive source, an electric vehicle having a traveling motor as the traveling drive source, and a hybrid vehicle having an engine and a traveling motor as the traveling drive source. The subject vehicle is capable of traveling not only in a self-drive mode that does not necessitate the driver's driving operation but also in a manual drive mode of the driver's driving operation.

The self-driving vehicle has a capability (hereinafter, referred to as a road departure mitigation capability) of recognizing a division line that defines a traveling lane of the subject vehicle and controlling a traveling actuator so that the subject vehicle does not depart to the outside of the traveling lane, based on information of the recognized division line.

As a method for recognizing the division line, by the way, there is a method for installing a stereo camera including two cameras in a front part of a subject vehicle, calculating a difference (parallax) between captured images obtained from the respective cameras, and recognizing a position and a shape of the division line, based on the parallax and a distance between the cameras. In the method for recognizing the division line by using one device (stereo camera) in this manner, when determining whether the recognized division line coincides with an actual division line, a high-precision map including detailed information of the actual division lines is necessary. However, the high-precision map is expensive. Hence, when trying to detect the erroneous recognition of the division line by using the high-precision map, there is a possibility that the cost of the vehicle is increased. Therefore, in the present embodiment, the vehicle control apparatus is configured as follows.

FIG. 1 is a block diagram schematically illustrating a substantial configuration of a vehicle control apparatus 100 according to an embodiment of the present invention. As illustrated in FIG. 1, the vehicle control apparatus 100 includes a controller 10, an imaging unit 1, an imaging unit 2, a communication unit 3, each of which is communicably connected with the controller 10, and a traveling actuator (an actuator for traveling) AC.

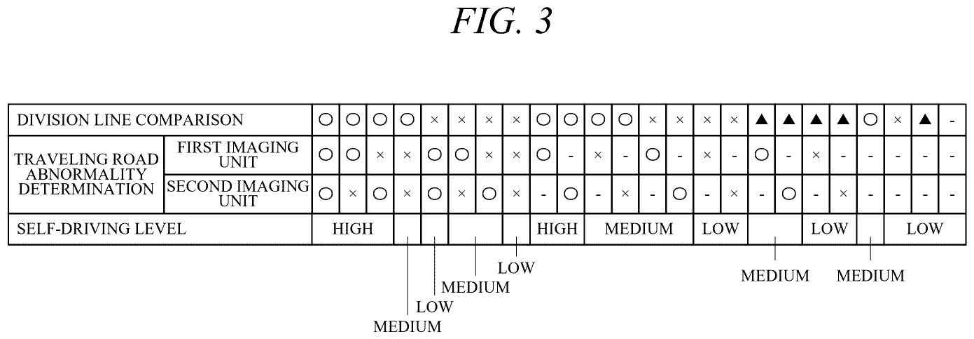

The imaging units 1 and 2 each include an imaging element (image sensor) such as a CCD or a CMOS. The imaging units 1 and 2 each image a predetermined area in the surroundings of the subject vehicle. FIG. 2 is a diagram illustrating an example of a subject vehicle 101, to which the vehicle control apparatus 100 is applied. As illustrated in FIG. 2, the imaging units 1 and 2 are respectively attached to predetermined positions (front part) of the subject vehicle 101, and continuously image a space on a forward side of the subject vehicle 101 to acquire image data (hereinafter, referred to as captured image data or simply a captured image). The imaging units 1 and 2 are installed so that their imaging ranges are substantially identical to each other. Note that the imaging units 1 and 2 may be different in manufacturer, type, performance, or the like from each other, and each may be configured in a single body. In addition, the imaging units 1 and 2 each may be a monocular camera or a stereo camera.

The imaging units 1 and 2 each further include a computer including a processing unit (not illustrated) such as a CPU (microprocessor), a memory unit (not illustrated) such as a ROM and a RAM, and another peripheral circuit, not illustrated, such as an I/O interface. The processing units of the imaging units 1 and 2 respectively include recognition units 1a and 2a each serving as a functional configuration.

The recognition units 1a and 2a recognize an external situation in a predetermined region in the surroundings of the subject vehicle 101, based on captured image data acquired by the imaging elements of the imaging units 1 and 2. Specifically, the recognition units 1a and 2a recognize a division line included in an imaging range, based on the captured image data of the imaging units 1 and 2. In addition, the recognition units 1a and 2a recognize an abnormality in a traveling road within the imaging range, based on the captured image data of the imaging units 1 and 2. The abnormality of the traveling road is to be a factor that hinders traveling of the subject vehicle 101, such as a division line abnormality of rubbing of a division line or the like, an obstacle of a falling object or the like, and a depression of a road. The recognition units 1a and 2a output, to the controller 10, information indicating recognition results of the division line (hereinafter, referred to as division line information) and information indicating a recognition result of an abnormality of a traveling road by the recognition units 1a and 2a (hereinafter, referred to as traveling road abnormality information). The recognition units 1a and 2a recognize the division line and the traveling road abnormality, by using respectively different algorithms. Therefore, the recognition units 1a and 2a output the division line information indicating the division lines that are respectively different in position or shape, based on different pieces of captured image data on an identical scene, in some cases. Similarly, the recognition units 1a and 2a output traveling road abnormality information indicating respectively different traveling road abnormalities, based on different pieces of captured image data on an identical scene, in some cases. Note that the recognition units 1a and 2a may output, to the controller 10, captured image data of the imaging units 1 and 2 together with the division line information and the traveling road abnormality information.

The communication unit 3 communicates with various devices, not illustrated, through a network including a wireless communication network represented by the Internet network, a mobile phone network, or the like. The network includes not only a public wireless communication network but also a closed communication network provided for every predetermined management area, for example, a wireless LAN, Wi-Fi (registered trademark), Bluetooth (registered trademark), and the like.

The controller 10 includes an electronic control unit (ECU). More specifically, the controller 10 includes a computer including a processing unit 11 such as a CPU (microprocessor), a memory unit 12 such as a ROM and a RAM, and another peripheral circuit, not illustrated, such as an I/O interface. Note that a plurality of ECUs respectively having different functions such as an ECU for engine control, an ECU for traveling motor control, and an ECU for a braking device may be individually provided. However, in FIG. 2, the controller 10 is illustrated as an aggregation of these ECUs for the sake of convenience.

The memory unit 12 stores information such as programs for various types of control and thresholds for use in the programs. The processing unit 11 includes a determination unit 111 and a control unit 112 each serving as a functional configuration.

The determination unit 111 acquires a difference between a recognition result of the division line based on captured image data by the imaging unit 1 that has been recognized by the recognition unit 1a, and a recognition result of the division line based on captured image data by the imaging unit 2 that has been recognized by the recognition unit 2a, based on the division line information from the imaging units 1 and 2 (recognition units 1a and 2a). The determination unit 111 determines a self-driving level to be applied to the subject vehicle 101, based on the acquired difference. The self-driving level indicates the degree of self-driving in a driving operation on a plurality of stages. Hereinafter, for simplification of description, it is assumed that the subject vehicle 101 has the self-driving capability divided into three levels including a high level, a medium level, and a low level. However, the self-driving level may be divided into any other levels than the three levels. The control unit 112 controls an actuator AC so that the subject vehicle 101 travels in accordance with the self-driving level that has been determined by the determination unit 111.

More specifically, in a case where the degree of coincidence between the division line that has been recognized, based on the captured image data by the imaging unit 1, and the division line that has been recognized, based on the captured image data by the imaging unit 2, is equal to or larger than a predetermined degree, the determination unit 111 determines that the reliability of the recognition result of the division line (hereinafter, referred to as division line reliability) is high, and determines the self-driving level to be a high level. When the self-driving level is determined to be the high level, the control unit 112 enables the road departure mitigation capability, and controls the traveling actuator so that the subject vehicle 101 travels in accordance with the recognized division line, that is, so that the subject vehicle 101 does not depart to the outside of the lane defined by the recognized division line.

On the other hand, in a case where the degree of coincidence between the division lines is smaller than the predetermined degree, the subject vehicle 101 has a possibility of departing from the road, when traveling in accordance with the recognized division line. Therefore, in the case where the degree of coincidence of the division lines is smaller than the predetermined degree, the determination unit 111 determines the self-driving level to be a medium level. When the self-driving level is determined to be the medium level, the control unit 112, while enabling the road departure mitigation capability, requests the occupant to perform a driving operation (steering wheel operation), as necessary, so that the subject vehicle 101 does not depart to the outside of the road. In this manner, when the self-driving level is determined to be the medium level, a state in which the road departure mitigation capability is enabled temporarily continues (until the driving operation is requested).

On the other hand, because of contamination or halation of a camera lens, the division line cannot be recognized, based on the captured image data by the imaging units 1 and 2, in some cases. In this situation, the recognition units 1a and 2a output the division line information indicating that it is impossible to recognize the division line to the controller 10. In such a case, the determination unit 111 is not capable of comparing the division lines that have been recognized by the captured image data by the imaging units 1 and 2 with each other, thus determines that the division line reliability is low, and determines the self-driving level to be a low level. When the self-driving level is determined to be the low level, the control unit 112 disables the road departure mitigation capability, and controls the traveling actuator, based on a driving operation of the occupant.

In determining the self-driving level of the subject vehicle 101, the determination unit 111 may consider the traveling road abnormality information from the imaging units 1 and 2. Specifically, the determination unit 111 determines the presence or absence of an abnormality of the traveling lane of the subject vehicle 101, based on the traveling road abnormality information from the recognition units 1a and 2a. In a case where the determination unit 111 determines that the division line reliability is high and at least one of pieces of the traveling road abnormality information from the recognition units 1a and 2a indicates that there is no abnormality of the traveling road, the determination unit 111 determines that it is possible to continue the road departure mitigation capability, and determines the self-driving level to a high level. On the other hand, in a case where at least one of the pieces of the traveling road abnormality information from the recognition units 1a and 2a indicates that there is an abnormality of the traveling road, a request for a driving operation to the occupant is necessitated in some cases in order to cause the subject vehicle 101 to avoid from a depressed road, an obstacle, or the like. Therefore, even though the determination unit 111 determines that the division line reliability is high, in a case where at least one of the pieces of the traveling road abnormality information from the recognition units 1a and 2a indicates that there is an abnormality of the traveling road, the determination unit 111 determines the self-driving level to be a medium level, instead of a high level. Furthermore, even though the determination unit 111 determines that the reliability of the recognition result of the division line is determined to be high, similarly also in a case where neither the recognition unit 1a nor 2a can recognize the abnormality of the traveling road because of the contamination or halation of the camera lens as described above, the determination unit 111 determines that there is a case where the request for the driving operation to the occupant is necessitated, and determines the self-driving level to be the medium level, instead of the high level.

Also, in a case where the determination unit 111 determines that the division line reliability is low, the determination unit 111 determines the self-driving level in consideration of the traveling road abnormality information from the imaging units 1 and 2, instead of determining the self-driving level to be a low level uniformly.

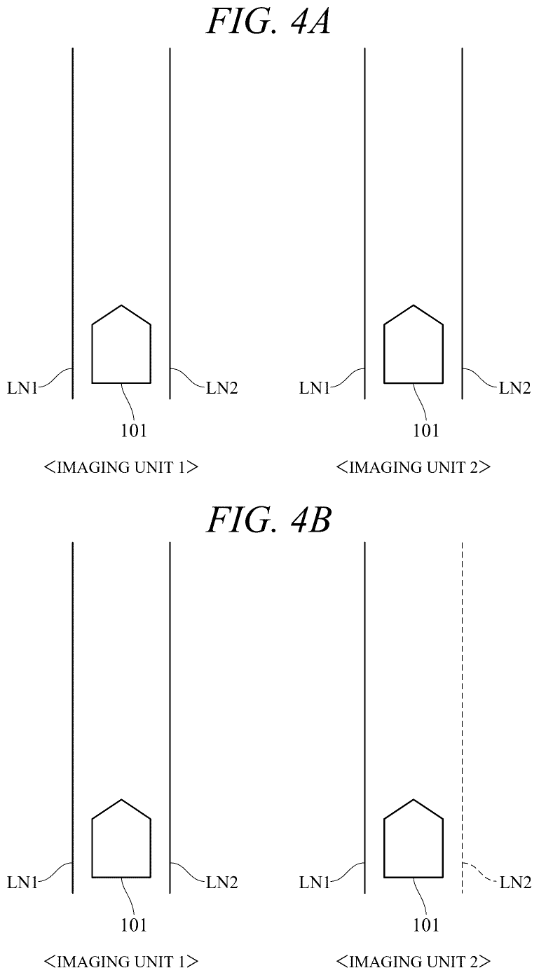

FIG. 3 is a diagram illustrating an example of a table for determining a self-driving level. The determination of the self-driving level by the above determination unit 111 is made, based on the table of FIG. 3. The table of FIG. 3 is stored beforehand in the memory unit 12. Note that the determination unit 111 may acquire the table of FIG. 3 from an external server or the like via the communication unit 3.

In the table of FIG. 3, “∘” given in a “DIVISION LINE COMPARISON” column indicates that the division lines of the recognition units 1a and 2a coincide with each other. “x” indicates that the division lines do not coincide with each other. “▴” indicates that one of the recognition units 1a and 2a is not capable of recognizing the division line. “-” indicates that neither the recognition unit 1a nor 2a can recognize the division line. “∘” given in a “TRAVELING ROAD ABNORMALITY DETERMINATION” column indicates that neither the recognition unit 1a nor 2a has recognized an abnormality of the traveling road. “x” indicates that the recognition units 1a and 2a each have recognized the abnormality of the traveling road. “-” indicates that neither the recognition unit 1a nor 2a was capable of recognizing the abnormality of the traveling road. A “SELF-DRIVING LEVEL” column indicates a self-driving level to be determined, based on information in the “DIVISION LINE COMPARISON” column and information in the “TRAVELING ROAD ABNORMALITY DETERMINATION” column.

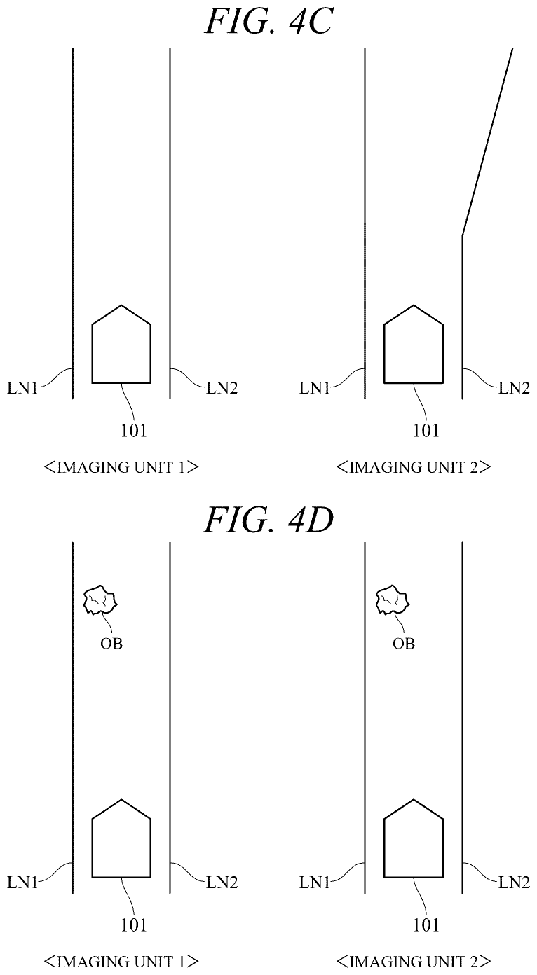

The operation of the vehicle control apparatus 100 according to the present embodiment will be summarized as follows. FIGS. 4A to 4D are diagrams for describing the operation of the vehicle control apparatus 100. FIGS. 4A to 4D schematically illustrate examples of division lines LN1 and LN2, which have been recognized by the recognition unit 1a, based on the captured image data by the imaging unit 1, and division lines LN1 and LN2, which have been recognized by the recognition unit 2a, based on the captured image data by the imaging unit 2. Note that in FIGS. 4A to 4C, it is assumed that no object or the like that hinders traveling of the subject vehicle 101 is present. As illustrated in FIG. 4A, in a case where the division lines LN1 and LN2, which have been recognized by the recognition units 1a and 2a, coincide with each other, the self-drive mode is determined to be a high level or a medium level, based on the traveling road abnormality information from the imaging units 1 and 2 in accordance with the table of FIG. 3.

On the other hand, as illustrated in FIG. 4B, in a case where the recognition unit 2a is not capable of recognizing the division line LN2 because of contamination or halation of the camera lens, the recognition results of the division lines by the recognition units 1a and 2a cannot be compared with each other. In this case, the self-drive mode is determined to be a medium level or a low level, based on the traveling road abnormality information from the imaging units 1 and 2 in accordance with the table of FIG. 3.

In a case where a lane (branch lane) that branches from the traveling lane of the subject vehicle 101 is included in the imaging range of the imaging units 1 and 2, a division line that defines the branch lane is erroneously recognized by the recognition units 1a and 2a as a division line that defines the traveling lane of the subject vehicle 101, in some cases. FIG. 4C illustrates an example of a case where a division line that defines a lane (branch lane) that branches from the traveling lane of the subject vehicle 101 has been erroneously recognized by the recognition unit 2a, as a part (an oblique part in the drawing) of the division line LN2, which defines the traveling lane of the subject vehicle 101. In this case, the shapes of the division lines LN1 and LN2 that have been recognized by the recognition units 1a and 2a do not coincide with each other, and thus the self-drive mode is determined to be a middle level or a low level, based on the traveling road abnormality information from the imaging units 1 and 2 in accordance with the table of FIG. 3.

In addition, as illustrated in FIG. 4D, when the recognition units 1a and 2a recognize an object OB, which hinders traveling of the subject vehicle 101, even though the division lines LN1 and LN2, which have been recognized by the recognition units 1a and 2a coincide with each other, the self-driving level is determined to a medium level in accordance with the table of FIG. 3, instead of a high level.

According to the present embodiment, the following operations and effects are achievable.

(1) The vehicle control apparatus 100 controls the subject vehicle 101 having either the self-driving capability or the driving support capability. The vehicle control apparatus 100 includes: the imaging unit 1 and the imaging unit 2, each of which detects an external situation in a predetermined region in the surroundings of the subject vehicle 101; the recognition units 1a and 2a, which recognize the external situation in the surroundings of the subject vehicle 101, based on a detection value (captured image data) by the imaging unit 1, and which also recognize the external situation in the surroundings of the subject vehicle 101, based on a detection value (captured image data) by the imaging unit 2; and the determination unit 111, which determines either the self-driving capability or the driving support capability to be applied to the subject vehicle 101, based on a difference between a recognition result based on the detection value of the imaging unit 1 and a recognition result based on the detection value of the imaging unit 2 that have been recognized by the recognition units 1a and 2a. Accordingly, the external situation in the surroundings of the subject vehicle 101 can be accurately recognized, so that either the self-driving capability or the driving support capability corresponding to the external situation can be appropriately determined. In addition, by appropriately determining either the self-driving capability or the driving support capability of the self-driving vehicle in this manner, traffic safety can be ensured, also in a case where self-driving vehicles become widely used and the number of self-driving vehicles traveling on the road increase.

(2) The recognition units 1a and 2a recognize a division line of a lane on which the subject vehicle 101 travels. The determination unit 111 determines either the self-driving capability or the driving support capability to be applied to the subject vehicle 101, based on a difference between the recognition results of the division lines by the recognition units 1a and 2a. Accordingly, the division line that defines the traveling lane of the subject vehicle 101 can be accurately recognized, and in addition, either the self-driving capability or the driving support capability corresponding to the recognition result can be appropriately determined.

(3) The imaging unit 1 and the imaging unit 2 are installed in the subject vehicle 101 such that imaging ranges are substantially identical to each other. The recognition units 1a and 2a recognize a division line of the lane on which the subject vehicle 101 travels, based on captured image data that has been acquired by the imaging unit 1 and the imaging unit 2. This eliminates the need for aligning the coordinate systems of the plurality of imaging units, so that the division line that defines the traveling lane of the subject vehicle 101 can be more accurately recognized.

(4) The recognition units 1a and 2a further recognize a factor (traveling road abnormality) that hinders traveling of the subject vehicle 101, based on a detection value by the imaging unit 1, and also recognize a factor (traveling road abnormality) that hinders the traveling of the subject vehicle 101, based on a detection value by the imaging unit 2. The determination unit 111 determines either the self-driving capability or the driving support capability to be applied to the subject vehicle 101, based on a difference between the recognition result of the division line based on the detection value by the imaging unit 1 and the recognition result of the division line based on the detection value by the imaging unit 2, by the recognition units 1a and 2a, and a difference between the recognition result of the traveling road abnormality based on the detection value by the imaging unit 1 and the recognition result of the traveling road abnormality based on the detection value by the imaging unit 2, by the recognition units 1a and 2a. Accordingly, either the self-driving capability or the driving support capability is determined in consideration of not only the recognition result of the division line that defines the traveling lane of the subject vehicle 101 but also the abnormality of the traveling road of the subject vehicle 101. Therefore, either the self-driving capability or the driving support capability corresponding to the external situation in the surroundings of the subject vehicle 101 can be determined more appropriately.

The above embodiments can be modified into various forms. Hereinafter, some modifications will be described. In the above embodiment, the imaging unit 1 and the imaging unit 2, as a first external environment detection unit and a second external environment detection unit, respectively detect the external situations in a predetermined area in the surroundings of the subject vehicle 101. However, the first external environment detection unit and the second external environment detection unit may be any unit other than the imaging unit (camera), and may be a radar or a LiDAR. In addition, in the above embodiment, the vehicle control apparatus 100 including the first imaging unit (imaging unit 1) as the first external environment detection unit and the second imaging unit (imaging unit 2) as the second external environment detection unit has been described as an example. However, the vehicle control apparatus may include three or more external environment detection units.

In the above embodiment, the determination unit 111 determines the self-driving level by using the table of FIG. 3. However, the determination unit may determine the self-driving level in another method without using the table. For example, the self-driving level may be determined in accordance with a predetermined processing flow for determining the self-driving level, based on the division line information and the traveling road abnormality information from the imaging units 1 and 2.

Further, in the above embodiment, the determination unit 111 determines the self-driving level, based on the division line information and the traveling road abnormality information from the imaging units 1 and 2. However, the configuration of the determination unit is not limited to this, as long as the determination unit determines either the self-driving capability or the driving support capability to be applied to the subject vehicle 101. For example, the determination unit may determine whether to enable a specific capability such as the road departure mitigation capability of the subject vehicle 101, based on the division line information and the traveling road abnormality information from the imaging units 1 and 2.

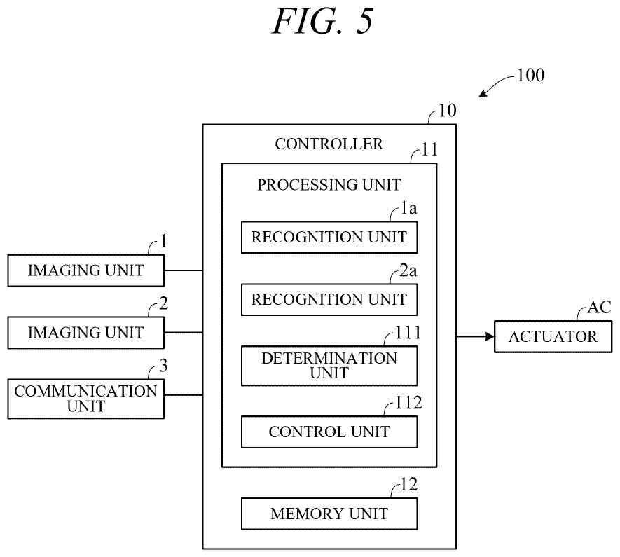

Furthermore, in the above embodiment, the vehicle control apparatus 100, in which the processing units of the imaging units 1 and 2 respectively function as the recognition units 1a and 2a each serving as a functional configuration has been described as an example. However, the configuration of the vehicle control apparatus is not limited to this. FIG. 5 is a block diagram schematically illustrating a substantial configuration of a vehicle control apparatus 100 according to a modification of an embodiment of the present invention. FIG. 5 illustrates an example of the vehicle control apparatus 100 in which the processing unit 11 of the controller 10 functions as the recognition units 1a and 2a each serving as a functional configuration. As illustrated in FIG. 5, in a case where the processing unit 11 includes the recognition units 1a and 2a each serving as a functional configuration, the recognition unit 1a acquires captured image data output from the imaging unit 1. The recognition unit 2a acquires captured image data output from the imaging unit 2. By using respectively different algorithms, the recognition units 1a and 2a recognize a division line included in the imaging range and an abnormality of a traveling road within the imaging range, based on the captured image data that has been acquired.

The above explanation is an explanation as an example and the present invention is not limited to the aforesaid embodiment or modifications unless sacrificing the characteristics of the invention. The aforesaid embodiment can be combined as desired with one or more of the aforesaid modifications. The modifications can also be combined with one another.

### REFERENCE SIGNS LIST

1, 2 imaging unit, 1a, 2a recognition unit, 3 communication unit, 10 controller, 12 memory unit, 111 determination unit, 112 control unit, AC actuator

1. A vehicle control apparatus configured to controlling a subject vehicle having either a self-driving capability or a driving support capability, the vehicle control apparatus comprising:
first and second external environment detection units configured to detect an external situation in a predetermined region in a surrounding of the subject vehicle, respectively;
a recognition unit configured to recognize the external situation in the surroundings of the subject vehicle based on a detection value by the first external environment detection unit, and recognize the external situation in the surroundings of the subject vehicle based on a detection value by the second external environment detection unit; and
a determination unit configured to determine either the self-driving capability or the driving support capability to be applied to the subject vehicle, based on a difference between a recognition result based on the detection value by the first external environment detection unit and a recognition result based on the detection value of the by the second external environment detection unit.

2. The vehicle control apparatus according to claim 1, wherein
the recognition unit is configured to recognize a division line of a lane on which the subject vehicle travels based on the first external environment detection unit; and
the determination unit is configured to determine either the self-driving capability or the driving support capability to be applied to the subject vehicle, based on a difference between a recognition result of the division line based on the detection value by the first external environment detection unit acquired in the recognizing and a recognition result of the division line based on the detection value of the by the second external environment detection unit acquired in the recognizing.

3. The vehicle control apparatus according to claim 2, wherein
the first external environment detection unit and the second external environment detection unit are a first and second imaging units imaging a space on a forward side of the subject vehicle, respectively,
the first and second imaging units are installed in the subject vehicle 101 such that imaging ranges are substantially identical to each other, and
the recognition unit is configured to recognize a division line of a lane on which the subject vehicle travels, based on captured image data acquired by the first imaging unit and the second imaging unit,

4. The vehicle control apparatus according to claim 2 or 3, wherein
the recognition unit is further configured to recognize a factor hindering a travel of the subject vehicle, based on the detection value by the first external environment detection unit, and also recognize a factor hindering the travel of the subject vehicle, based on a detection value by the second external environment detection unit, and
the determination unit is configured to determine either the self-driving capability or the driving support capability to be applied to the subject vehicle, based on a difference between the recognition result of the division line of a lane on which the subject vehicle travels based on the detection value by the first external environment detection unit and the recognition result of the division line of a lane on which the subject vehicle travels based on the detection value by the second external environment detection unit, and a difference between the recognition result of the factor hindering the travel of the subject vehicle, based on the detection value by the first external environment detection unit and the recognition result of the factor hindering the travel of the subject vehicle, based on the detection value by the second external environment detection unit.
